(19) United States
(12) Patent Application Publication
(10) Pub. No.: US 2018/0283100 A1
(43) Pub. Date: Oct. 4, 2018

(54) RETRACTABLE PRIVACY SYSTEM AND METHOD

(71) Applicant: David R. Hall, (US)

(72) Inventors: David R. Hall, Provo, UT (US); Andrew Priddis, Mapleton, UT (US); Charles Wood, Sandy, UT (US); Grant Getts, Provo, UT (US)

(73) Assignee: David R. Hall, Provo, UT (US)

(21) Appl. No.: 16/000,787

(22) Filed: Jun. 5, 2018

Related U.S. Application Data
(63) Continuation-in-part of application No. 15/078,307, filed on Mar. 23, 2016.
Application No. 15/078,307 is a continuation-in-part of application No. 14/740,252, filed on Jun. 15, 2015, now Pat. No. 9,996,809.

(51) Int. Cl. E06B 9/72; E06B 9/42

(52) U.S. Cl. CPC E06B 9/72; E06B 2009/405; E06B 9/42

(57) ABSTRACT

A retractable privacy system and method are disclosed. The system has two or more drums having one or more motors inside each of the respective drums. A flexible sheet is rotated around each of the respective drums by the respective motors to roll-up or roll-down the respective flexible sheets. Each of the respective flexible sheets has side edges which are parallel to each other and perpendicular to a top edge and a bottom edge. A flexible mating surface is attached to each side edge and is configured to connect with the flexible mating surface of the adjacent flexible sheet. A battery and a motor controller are located inside the respective drums. The system further includes a beacon comprising a communication tilt plate comprising a front side and a back side. The front side has an outer touch surface, while the back side has electronic components mounted thereon. The back side further also has a raised center pivot and a plurality of spring loaded switches mounted thereon disposed around the periphery of the back side of the tilt plate. In this way, tilting the communication tilt plate by pressing proximate the periphery of the outer touch surface one or more of the spring-loaded activates the switches to thereby communicate commands to the respective motor controllers. In particular, the respective motor controllers receive commands to roll-up or roll-down the respective adjacent flexible sheets thereby connecting and disconnecting the respective flexible mating surfaces of the respective flexible sheets.

### CROSS-REFERENCE TO RELATED APPLICATIONS

This application is a continuation-in-part of pending U.S. patent application Ser. No. 15/078,307, entitled “A Retractable Privacy System and Method,” filed Mar. 23, 2016, and a continuation-in-part of co-pending U.S. patent application Ser. No. 14/740,252, entitled “Apparatus and Method for Tracking and Gathering Information Associated with Assets,” filed Jun. 15, 2015.

The foregoing patent applications are incorporated herein by this reference for all that they contain.

### TECHNICAL FIELD

This invention relates to retractable walls, windows, doors, insulation, sound barriers, and other retractable or reconfigurable privacy systems and methods.

### BACKGROUND

Roller shades, roller blinds, and roller awnings have been developed to meet the needs of blocking light and keeping out bugs and mosquitoes. But these technologies lack specific environmental and insulating properties.

### SUMMARY

In a first aspect, the invention is a retractable privacy system having two or more drums, each of the drums containing one or more motors inside each of the respective drums. A flexible sheet is rotated around each of the respective drums by the respective motors to roll-up or roll-down the respective flexible sheets. Each of the respective flexible sheets has side edges which are parallel to each other and perpendicular to a top edge and a bottom edge. A flexible mating surface is attached to each side edge of each of the flexible sheets. The flexible mating surface is configured to connect with the flexible mating surface of the adjacent flexible sheet. A battery is located inside the respective drums to power the respective motors. A motor controller is disposed within the respective drums. The system further includes a beacon comprising a communication tilt plate comprising a front side and a back side. The front side has an outer touch surface, while the back side has electronic components mounted thereon. The back side further also has a raised center pivot and a plurality of spring loaded switches mounted thereon disposed around the periphery of the back side of the tilt plate. In this way, tilting the communication tilt plate by pressing proximate the periphery of the outer touch surface one or more of the spring-loaded activates the switches to thereby communicate commands to the respective motor controllers. In particular, the respective motor controllers receive commands to roll-up or roll-down the respective adjacent flexible sheets thereby connecting and disconnecting the respective flexible mating surfaces of the respective flexible sheets.

In a second aspect, the invention is a method that uses the components of the system described above.

Preferably, the multiple motors and drums may work in synchronization. The retractable system may also communicate with a thermostat or security system to achieve a desired result.

Consistent with the foregoing, a retractable privacy system for providing dynamic humidity, temperature, lighting, air pressure, security, access, and insulation control of an area is disclosed. A corresponding method is also disclosed and claimed herein. Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative, and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a perspective view of a single sheet of a privacy system.

FIG. 2 is a perspective view of three sheets of a privacy system.

FIG. 3 is a perspective view a 90-degree configuration of a privacy system.

FIG. 4 is a side view of a double sheet configuration of a privacy system.

FIGS. 5A and 5B show a front view of a garage in accordance with an embodiment of the current invention.

FIGS. 6A and 6B show a front view of a doorway in accordance with an embodiment of the current invention.

FIGS. 7A and 7B show a front view of a garage in accordance with an embodiment of the current invention.

FIGS. 8A and 8B show a front view of a doorway in accordance with an embodiment of the current invention.

FIG. 9 is a cross-sectional view of an embodiment of a drum in accordance with an embodiment of the current invention.

FIG. 10 is a diagram of privacy system inputs and outputs in accordance with an embodiment of the current invention.

FIG. 11A is a front view of a beacon comprising a communication tilt plate of the current invention.

FIG. 11B is a front view of a dual gang beacon of the present invention.

FIG. 12 is a front view of a beacon comprising a communication tilt plate of the current invention.

FIG. 13A is back side view of a tilt plate of the current invention comprising a center ridge pivot.

FIG. 13B is a back side view of a tilt plate of the current invention comprising a spherical center pivot.

FIG. 13C is a back side view of a tilt plate of the current invention comprising peripheral switches.

FIGS. 14A and 14B are front side views of the tilt plate of the current invention comprising visual indicators.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

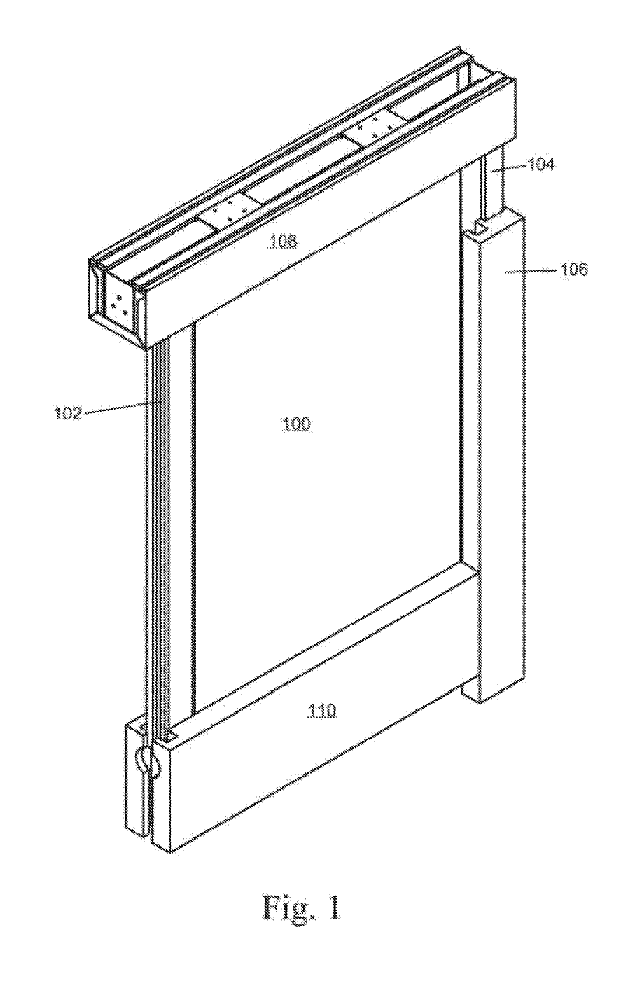

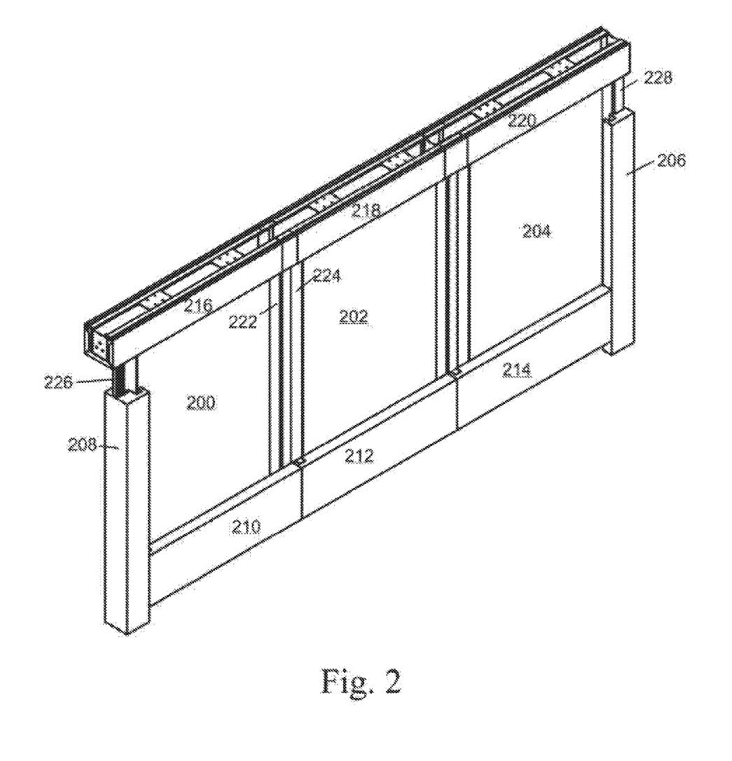

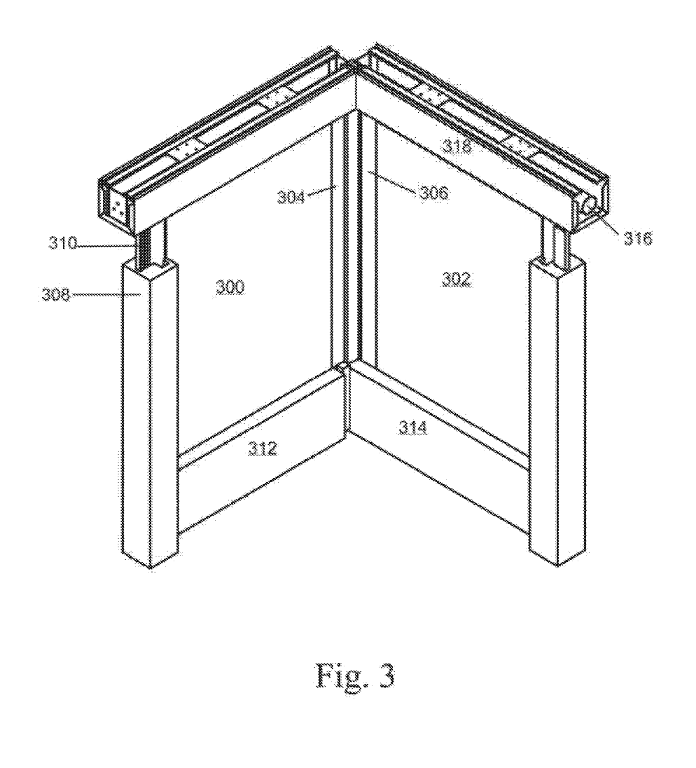

Referring to FIG. 1, a privacy system is shown having a flexible sheet 100. Flexible sheet 100 may be at least partially made of plastic, nylon, polyvinylidene fluoride, polyethylene, metal, lead, a metal alloy, polyvinylchloride, or vinyl. In a preferred embodiment flexible sheet 100 has a density of greater than 0.05 lb/in.sup.3 and a thickness of less than 0.2 of an inch. The high density of the sheet material 100 is necessary in order to achieve insulation against noise and heat transfer. Insulation against electromagnetic radiation may also be achieved by having a sheet 100 with one or more layers of an iron containing element. A flexible sheet may also be impregnated with various types and forms of material to obtain a desired shielding. Shielding against nuclear particles may also be achieved by adding a layer of lead or other heavy metal between layers or laminated within sheet 100. Flexible sheet 100 may be a continuous flexible sheet having a length of between 6 to 10 feet and a width of 7-10 feet and a thickness of less than 0.2 of an inch. A flexible interface or flexible mating surface 102 and 104 is attached to or molded into flexible sheet 100. Sheet 100 and flexible interface surfaces 102 and 104 roll up into headrail 108. Flexible interface or flexible mating surface 102 and 104 are configured to interlock with each other so that additional sheets may be added as shown in FIGS. 2-3. Opposite side edges of the flexible interfaces 102 and 104 have the ability to interlock with one another. Drawbar 110 connects to a bottom edge of sheet 100. Drawbar 110 moves up and down with sheet 100 and may be hid inside of head rail 108 when sheet 100 is in a fully retracted position. Fixed side rail 106 may be used to secure one edge of sheet material 100 to a wall or other secure structural element by way of flexible interface 102 or 104.

Referring now to FIG. 2, a multiple sheet privacy system is shown in a straight line. Each of the sheets 200, 202, and 204 may be 8 feet wide and 8 feet high and ⅛-inch-thick spanning a distance of 24 feet from side rail 208 to side rail 206. Each sheet may raise or lower individually or synchronously. Drawbars 210, 212, and 214 each interconnect with each other when in a fully retracted position as shown in FIG. 2. Flexible material 222, 224, 226 and 228 are all similar mating surfaces which interconnect with one another. A particular mention is made to the fact that sidewall 208 interfaces with the same flexible design 226 which also is used when mating flexible surfaces 224 and 222. This allows greater flexibility in design and placement of sheets 200, 202, and 204 when making a privacy area.

In FIG. 3, sheets 300 and 302 are connected together at an angle at flexible interfaces 304 and 306. Drawbars 312 and 314 interconnect at an angle. It should be noted that no ridged sidewall interface is needed where flexible interfaces 304 and 306 connect. This allows greater flexibility in privacy area design. Drum 316 is shown in headrail 318. Headrail 318 is not drawn to scale and may be larger depending on the length and thickness of sheets 302 and 300.

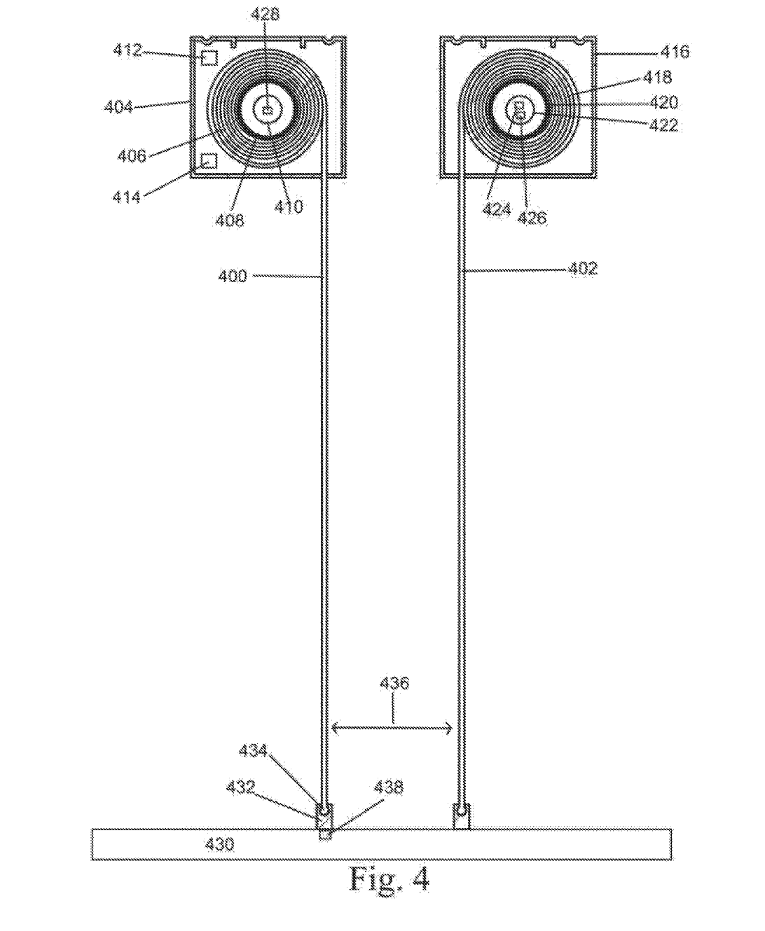

Now referring to FIG. 4, a side view of two flexible sheets are shown used in combination for greater insulation and privacy. This type of system could be used in place of a wall in a home. Space 436 is space between flexible sheets 400 and 402. This space may be chosen to represent a common wall thickness such as 3-4 inches. Headrail 404 houses a drum 408. Flexible sheet 400 is rolled up around drum 408 as shown at 406. Drum 408 may contain a motor 410. Motor 410 may be used to retract or extend flexible sheet 400. Motor 410 may contain an encoder 428 for tracking and determining a position of flexible sheet material in reference to ground surface 430. A braking mechanism may also be attached to motor 410 for providing a way of holding flexible sheet material in a fixed position. A controller 412 may also be included in headrail 404 as shown in FIG. 4 or may be attached to the motor as shown at 424. Additionally, the controller 412 may be located inside of drum 408 or drum 420. A battery 414 may be located in headrail 404 or in drum 408 or attached to motor 410. Controller 412 may contain a processor and a motor controller and a wireless communication system. One or more controllers 412 and 424 may be used to form a network. The network may be a wireless network. Motors 410 and 420 may be operated in a synchronous manner or may be operated individually. Additionally, more than one motor 410 may be located in a single drum 408. Each of the motors may be operated by a separate controller or by a separate motor controller within a single controller. Drawbar 432 may be made from an extruded metal and have additional weight added to it to hold flexible sheet material 400 in a taut position. Drawbar 432 may also be connected to ground surface 430 by a magnetic force 438 or other mechanical means.

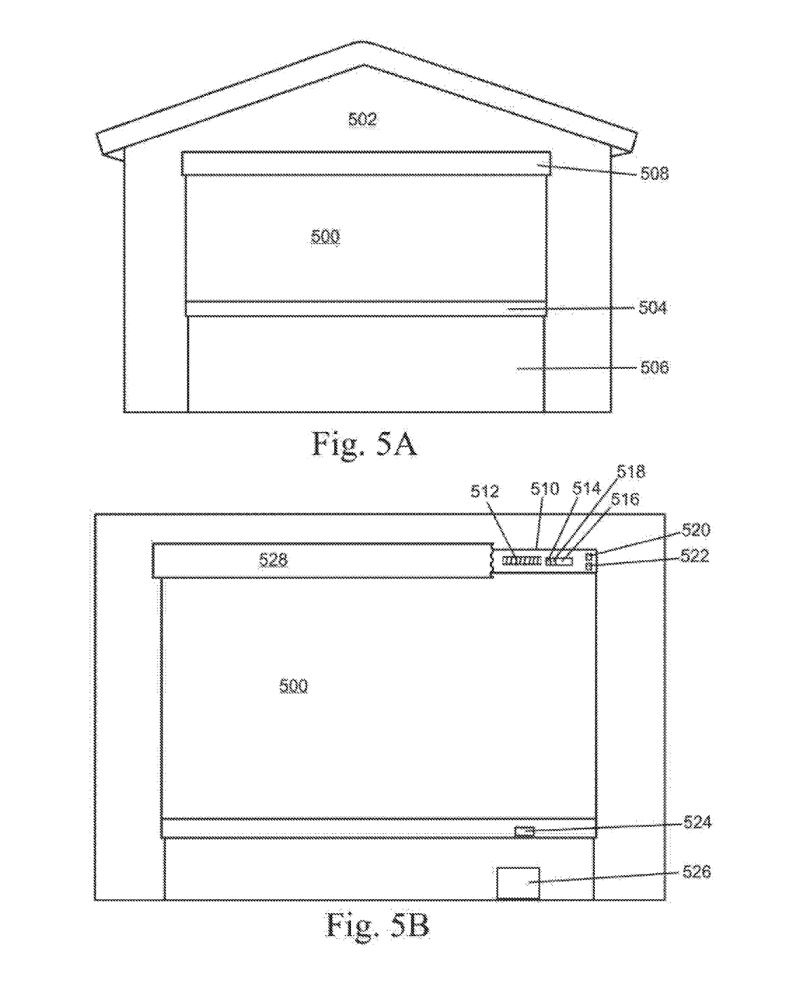

Now referring to FIG. 5A, a garage 502 is shown with flexible sheet material 500 used as the garage door. Opening 506 connect an area which is outside of garage 502 with an area inside of garage 502. In this instance, flexible sheet material 500 is used instead of the garage door. In FIG. 5B, we see a view of inside of headrail 528. Headrail 528 may include one or more springs 512 for assisting the motor 516 in opening and closing flexible sheet material 500. Motor 516 may include a locking or braking mechanism 518 for locking sheet material in a fixed position. Motor 516 may also be connected to an encoder 514 for determining position and tracking a position of flexible sheet material 500. Motor 516 may also be used as a generator while lowering sheet material 500 and charge battery 522. A sensor 524 may be used to detect an obstruction 526 and may provide feedback to controller 520. The flexible sheet material may be stopped from lowering upon detection of an obstruction in its path.

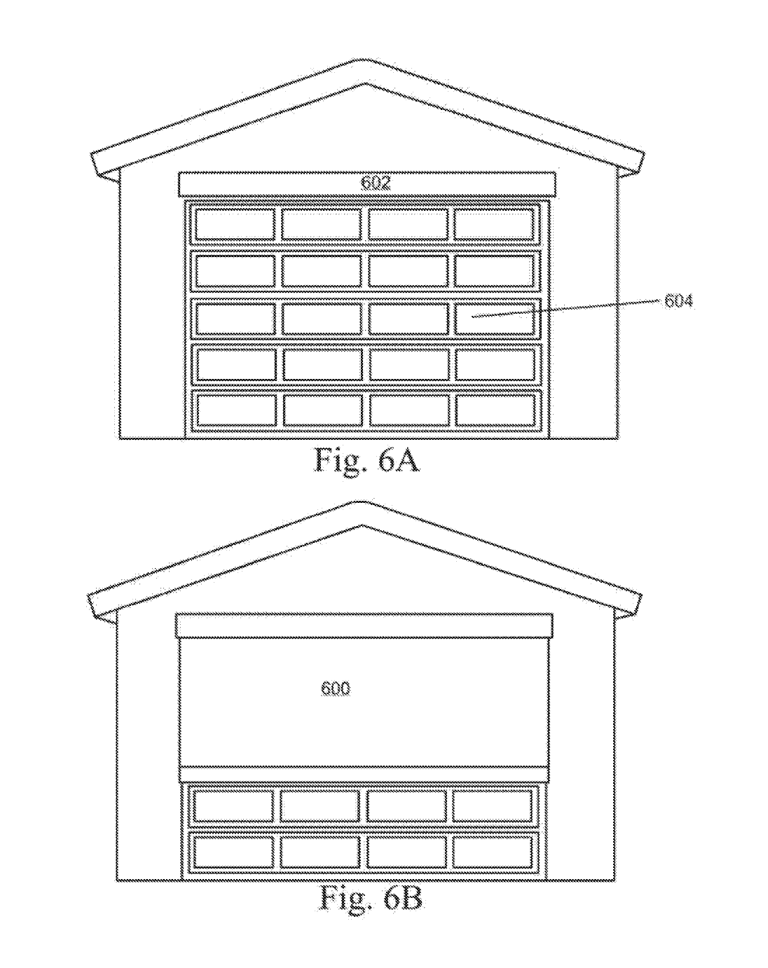

In FIGS. 6A and 6B, flexible sheet material 600 is used in combination with an existing garage door 604. Flexible sheet material 600 may be used on an inside of a garage or on the outside of a garage to cover a garage door and provide additional heat and sound insulation value.

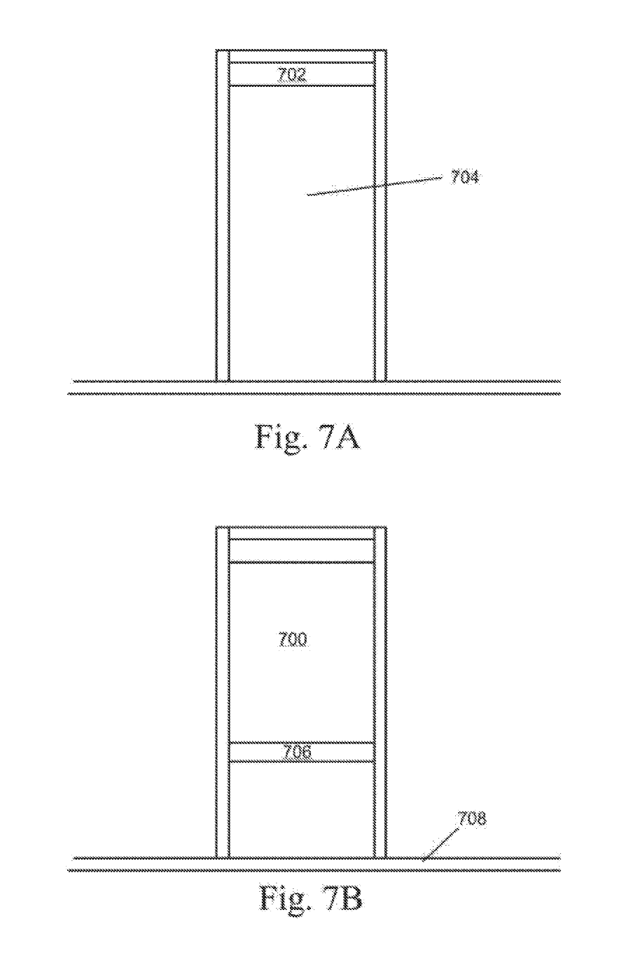

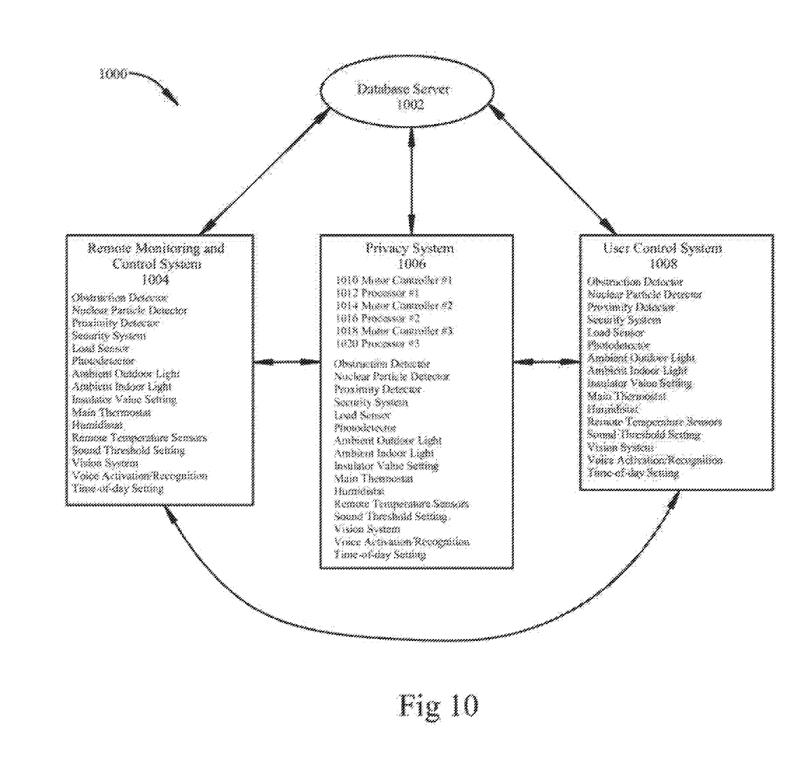

FIGS. 7A and 7B show a flexible sheet material 700 used as a door in an entrance way 704. A controller may be configured to open and close the sheet material in response to various inputs and outputs as described in relation to FIG. 10.

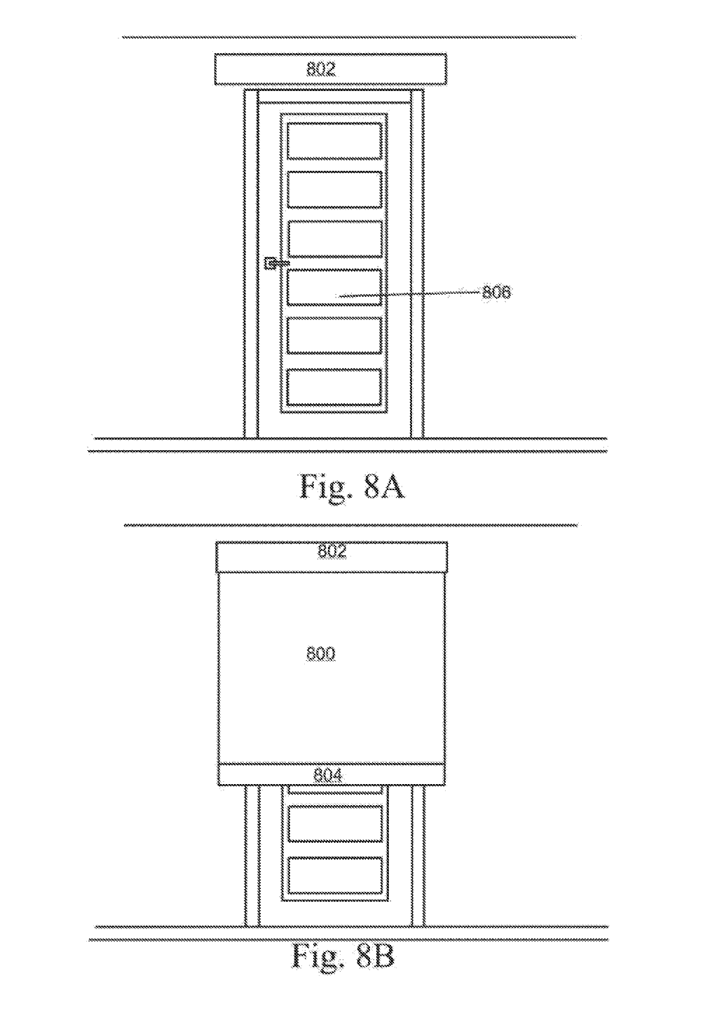

In FIGS. 8A and 8B, flexible sheet material 600 is used in combination with an existing garage door 604. Flexible sheet material 800 may be used on an inside of an entryway door 806 or on the outside of an entryway door provide additional heat and sound insulation value. Doors are not good sound insulator and flexible sheet material provides extra heat and sound insulation value to an existing door.

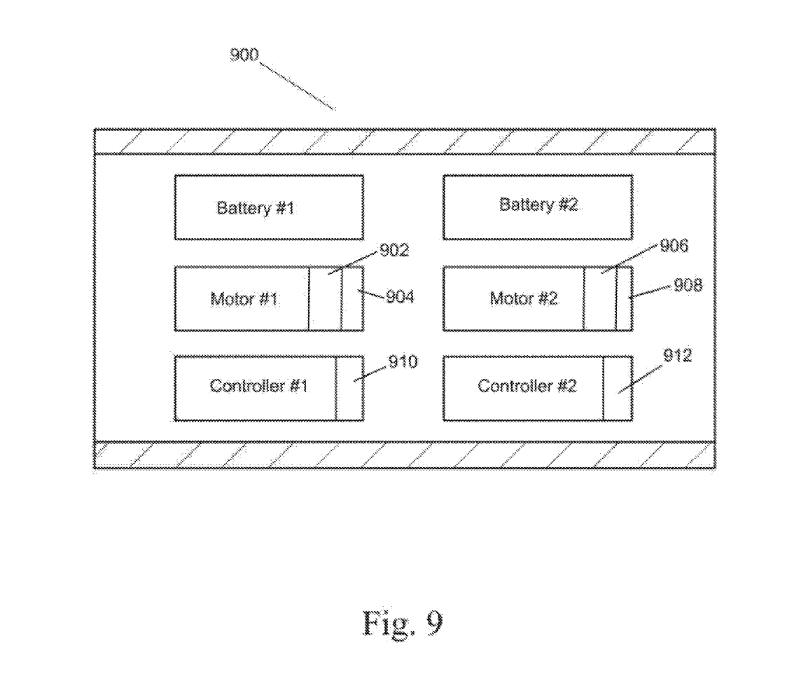

FIG. 9 shows an inside view of a drum 900. The single drum contains two motors, two batteries, and two controllers. Alternatively, the two motor may use a single controller and a single battery. A controller may contain a wireless control section 910 or 912 for networking the controller together and also for communicating with a remote wireless system. Wireless control section 910 and 912 may use Wifi, Bluetooth, Zigbee, Sure-fi and/or cellular communication technology to communicate with sensors and with remote systems. Wireless control section 910 and 912 may be used to synchronously lift a single flexible sheet or multiple flexible sheets.

FIG. 10 shows various inputs and outputs in connection with one or more controllers as shown in FIGS. 4, 5 and 9. Privacy system 1006 may be connected to locally or remotely to database server 1002, remote monitoring and control system 1004, user control system 1008, or to any combination thereof. Privacy system 1006 may contain one or more motors within one or more drums. A single drum may contain multiple motors working synchronously in order to achieve proper lifting of a heavy or dense sheet material. For example, a 10′.times.10′ sheet of mass loaded vinyl with a density of 0.060 lb/in.sup.3 weighing over 100 lbs. may need to be lifted by multiple motors. In another example, multiple motors may be operated to lift or lower multiple flexible sheets to create a privacy area or to make an opening large enough for a specific use. Privacy system 1006, Remote monitoring system 1004, and User Control system 1008 may be networked together and each have similar sensor inputs or the ability to read sensor data. Sensor data may include a time-of-day setting, detection of an obstruction in a path of a flexible sheet material, detection of a proximity of a specific person, detection of a nuclear particle, detection of a security issue, an indoor photodetector, an outdoor photodetector, an input from a thermostat, an input from a humidistat, a remote temperature sensor, a sound or noise level, a vision sensing system, a user recognition system, etc.

In an example, a proximity detector may detect a movement at a doorway and automatically rollup a sheet material. A specific person may be recognized by RFID or by a vision recognition system and the doorway may be opened based on access privileges of the specific person. Voice activation and recognition may also be used to distinguish a specific person and open a doorway on command or just to open a doorway based on a specific command with indifference to the person.

In another example, one or more photodetectors may be used to determine a brightness value of light inside and outside. A user setting may be compared to the brightness values and a decision to open or close a flexible sheet material may be made automatically. This could be used in homes, offices, and greenhouses. Similarly, temperature values can be determined on each side of a flexible sheet and a determination may be made to open, close or partially open or partially close a flexible sheet material based on a user threshold setting such as a predetermined temperature setting or humidity setting or lighting setting or a combination of threshold settings.

In another example, a privacy system may provide an input signal to a security system. If motion is detected or if the flexible sheet material is cut or torn or moved out of place manually, a security signal could be sent to a security system or to a cellular phone. A security system might then make a decision to report an intrusion or take other action. A security system might retract and extend one or more flexible sheets in order to scare or deter a robber, the robber thinking that someone is present. A text message might be sent to a phone or a recorded voice message might be delivered.

In another example, a nuclear particle detector detects radioactive particles and drops down all flexible sheets which contain lead or another heavy metal to keep radioactive particle from getting into a specific area.

In another example, a thermostat sends a signal to open a flexible sheet material based on at least two temperatures. A home or building may be temperature balanced by opening and closing flexible sheet materials. This may also be accomplished automatically, by local sensors connected to a controller of a flexible sheet doorway. Pressure may also be controlled within one or more areas by opening or closing a flexible sheet doorway.

In another example, a flexible sheet controller receives a wireless signal reporting an outside temperature drop below a threshold value of an inside temperature value and a flexible sheet controller lowers one or more flexible sheet materials in response to an outside temperature falling.

In another example, a flexible sheet controller receives a wireless signal reporting an outside temperature rise above a preset threshold value of a current inside temperature and, in response, a flexible sheet controller raises one or more flexible sheet materials in response to an outside temperature rising.

Humidity may also be controlled by raising and lowering flexible sheet materials. Dynamic sound damping may also be accomplished by raising and lowering flexible sheet material.

In another example, a privacy system with a single flexible sheet is commanded to roll-up. Multiple motors work together within a single drum to roll-up the flexible sheet.

User control system 1008 may include a computer, a laptop, a cellular phone, a wireless remote control device, a battery-less wireless remote control device, a passive RFID card or FOB, or a cloud-based user interface console.

Privacy system 1006 may include one or more controllers for controlling one or more motors and communicating with remote monitoring and control system 1004 and/or user control system 1008 by way of database server 1002 or directly.

Remote monitoring and control system 1004 may be maintained remotely by a third party such as a security company, a maintenance company, and/or a management company.

The retractable privacy system and method disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

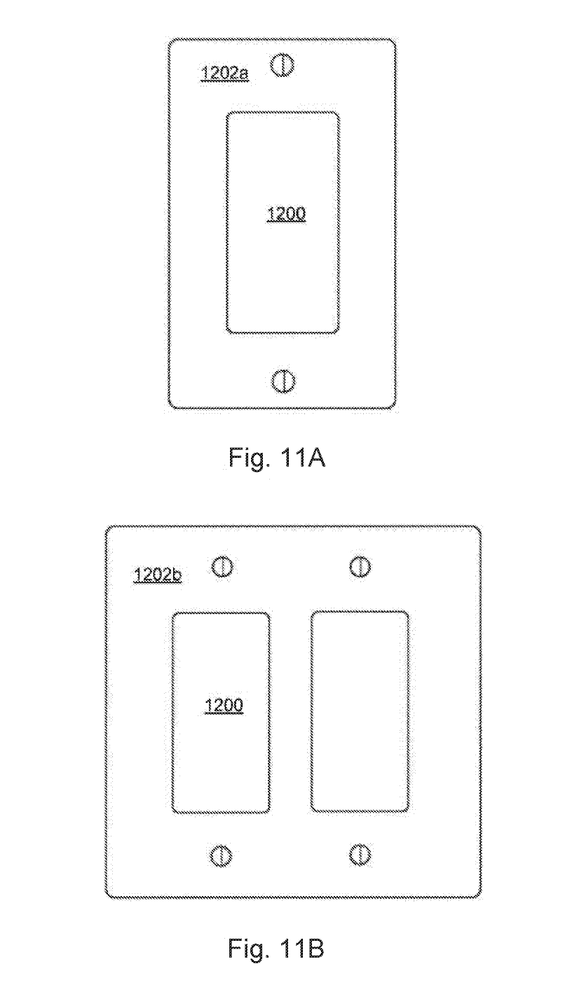

Referring generally to FIGS. 11A through 15, how beacons are implemented in hardware may vary in different embodiments. Beacons may use a variety of different communication protocols, including Bluetooth-based protocols such as iBeacon, RFID, 802.11, and other technologies. The protocol selected may be based on a desired communication range, power usage, reliability, and the like.

The manner in which beacons are powered may vary in different embodiments. Beacons may, in certain embodiments, be powered by a small rechargeable battery or capacitor. Stationary beacons may be hardwired into existing electrical systems to increase reliability and reduce the need for low power electronics. A battery backup may be provided in stationary implementations if needed or desired. In certain embodiments, a solar cell or other energy harvesting technology may be used to maintain a battery charge and reduce or eliminate the possibility of a discharged battery that renders the device inoperative. Advanced use of solar or other ambient energy harvesting such as radio frequency energy collection may reduce or minimize the potential for data loss or system control issues due to discharged batteries. It may also allow for smaller batteries or even the elimination of batteries and use of capacitors to level energy harvesting fluctuations. Solar cells with logic, sensor, and radio components integrated via a laminated printed circuit board (PCB), or adhesively mounted to form a lightweight and very thin profile, can be weather proofed and integrated into a variety of platforms.

In other embodiments, beacons may be powered using insulated, spring-closed, clips/clamps with ferrite components to enable easy installation to a light switch or electrical plug by clamping around the neutral and common wires, over their insulation. Such an embodiment allows for charging of an onboard battery whenever the switch is on or a device is plugged into an outlet and used which causes electrical current to pass through the clamps.

Various sensors may be incorporated into a beacon's circuit board. These sensors may be used to automate local functions or may be relayed to a smart device/application or a central system for monitoring, trending, and control functions. For example, temperature sensors may be used to control environmental systems locally in an automated system, and/or provide override capabilities in a local or centralized system. Ambient light sensors may be used to control lighting fixtures or circuits, automated window covering systems, and the like. Motion may be detected using accelerometers, gyroscopes, or other sensors to detect movement including vibration. A timer/clock may be incorporated into the beacons to activate/deactivate processes or devices based on time of day, elapsed time, or a preconfigured schedule. Electrical current sensors may be used to determine power consumption, power density, measure start and stop times of activity, total run time, and the like.

Proximity sensors may be used to detect other beacons or radio frequency sources, light of a specific frequency or brightness, magnetic fields, or other objects or energy sources that are in close proximity to a beacon. Touch sensors such as physical buttons, capacitive touch sensors, or other types of touch sensors may be used to activate features, acknowledge inputs, and the like. Longer touch sensors built into the edge of a solar cell or front of a beacon device may be used to provide sliding functions to increase/decrease a parameter. Pressure sensors may be used to detect pressure changes due to weather, detect movement via localized pressure changes, detect opening of doors/windows, or the like. Audio sensors may be used to detect the breakage of doors/windows, and/or recognize voice or sound patterns. Optical sensors may be used to recognize patterns in order to sense gestures, facial or other features, barcodes, or additional visible or invisible optically recognizable features. GPS sensors may be used to acquire and record location information from Global Positioning System satellite signals. Chemical sensors may be used to monitor/detect presence or change in environmental chemicals such as carbon monoxide, smoke, radioactive particles, dust, and the like.

In certain embodiments, a speaker with a tone generator or other output to acknowledge button presses or other actions may be included in a beacon to provide feedback either through audible sound or vibration. This can be used in a “find-me” mode where the beacon emits a tone to assist in locating the beacon and the asset that it is attached to. In other or the same embodiments, small LEDs or other light-emitting devices may be included to provide feedback in place of or to supplement audio tones or vibration. Additionally, it is also contemplated that a LCD, LED or other display may be used to provide interactive menus for a beacon in certain embodiments.

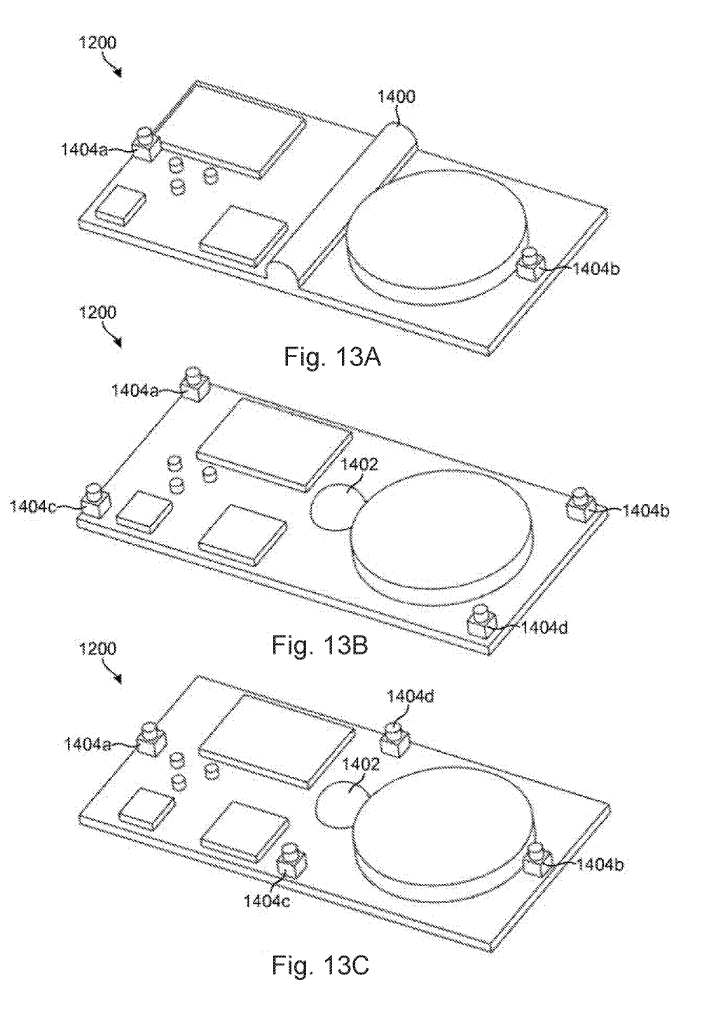

Input to the beacon may be provided by various buttons or touch sensors and various input codes may be used to activate specific functions. These may include, but are not limited to, quick touch, longer touch, sequential touches, code of touch such as pressing two buttons in a specific sequence such as AABA, AABB, or ABAB etc. to activate various functions and responses to the system. Buttons may be arranged and mounted in a variety of ways according to the purpose of the device. These buttons may be used for item selection, Yes/No, plus/minus, increase/decrease, on/off, acknowledge/cancel, and/or the like. Buttons may be mounted on the front of the device for direct press or the device itself may be mounted on a one, two, or three-dimensional rocker mount that allows for pressing of the device. This may activate one or more buttons by pressing the button against the mounting surface, as will be discussed in association with FIGS. 13A through 13C. Return to a neutral position may be accomplished via a variety of elastic or springy materials such as metal or plastic springs, springy foam materials, or the like.

FIG. 11A shows one embodiment of beacon 1200 mounted in a standard rocker light switch cover 1202a. The center switch portion is a beacon device 1200 with an integrated solar cell facing outward and electronics and switch features hidden behind a cover. The external dimensions are designed such that it allows for integration of a standard rocker-type switch cover 1202a that is attached directly to a surface such as a wall with no alteration or holes other than the face plate mounting holes. The beacon may be attached to a wall or surface by covering the beacon with the wall plate and attaching the wall plate to the wall or surface. In certain cases, a beacon 1200 may be added to a current wall-mounted electrical switch location by adding the beacon 1200 device to one side and changing to a dual gang or larger panel cover 1202b and mounting the beacon device 1200 or devices in the additional opening(s), as shown in FIG. 11B.

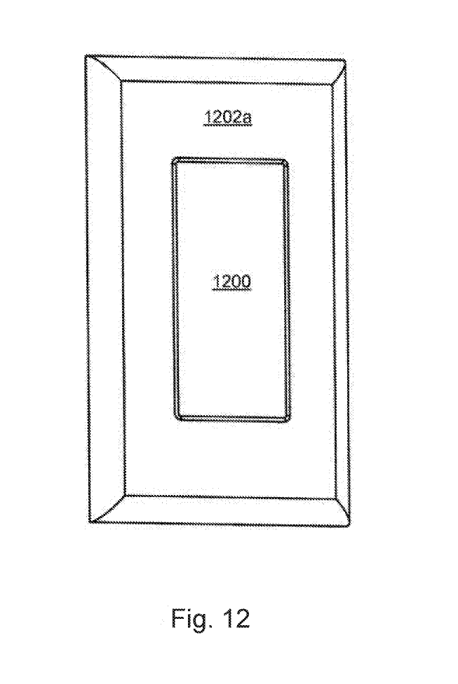

FIGS. 12 and 13A-C show a beacon device 1200 configured to fit in a standard, rocker light switch cover 1202a. As shown in FIG. 12, the beacon device 1200 fits into that opening and the wall plate 1202a is affixed to the wall with standard screw or other mounting systems. FIGS. 13A-C show various embodiments of the back of a beacon device 1200, which is held against a wall by a wall plate 1202. FIG. 13A shows one embodiment of a beacon device 1200 that pivots along a center ridge 1400 held against a wall. FIGS. 13B and 13C show embodiments of a beacon device 1200 that pivot around a partial spherical feature 1402 held against a wall.

In the embodiment of FIG. 13A, pressing either end of the device will actuate a switch 1404a, 1404b on the respective end. The switch 1404a, 1404b may be spring loaded with an elastic material to cause it to return a neutral position after being pressed. This type of input operation will work with one, two, three, four or more switches 1404 arranged in appropriate locations around a fulcrum type of feature. FIG. 13B shows a configuration having switches 1404a-d in the corners and a partial sphere feature 1402 that allows the device to pivot around its center. Pressing a corner will actuate the switch 1404 under the corner. Pressing an edge will actuate two corner switches 1404 simultaneously, enabling additional types of inputs or selections. FIG. 13C shows a configuration having switches 1404a-d located on the edges of the device 1200. Pressing an edge will actuate the switch 1404 under the edge. Pressing a corner will actuate two edge switches 1404 simultaneously, enabling additional types of inputs or selections.

The beacon devices 1200 shown in FIGS. 13A through 13C may be used either in stationary or mobile applications. The ability to use a beacon 1200 as an input device allows the beacon to be used in a wide variety of different applications. For example, the inputs on the beacon may be used to control a wide variety of different devices. In one contemplated embodiment, the beacon device enables a large number of different devices (e.g., window blinds or groups of window blinds, lights, fans, heating systems, cooling systems, etc.) to be controlled without requiring separate controls for each device or system. For example, using the directional switches 1404 illustrated in FIG. 13C, actuating the switches 1404 on the sides of the device 1200 may be used to select a device or system to control, whereas actuating the top and bottom switches 1404 may be used to adjust an amount associated with the device or system. Specifically, actuating the switches 1404 on the sides of the device 1200 enables a user to select a current function for the beacon device 1200. A set of indicators (e.g., colored LEDs, LEDs with accompanying pictures or icons, etc.) may optionally be provided to indicate the current function of the beacon device 1200. Actuating the switches 1404 on the top/bottom of the device 1200 enables the user to increase or decrease an amount associated with the current function.

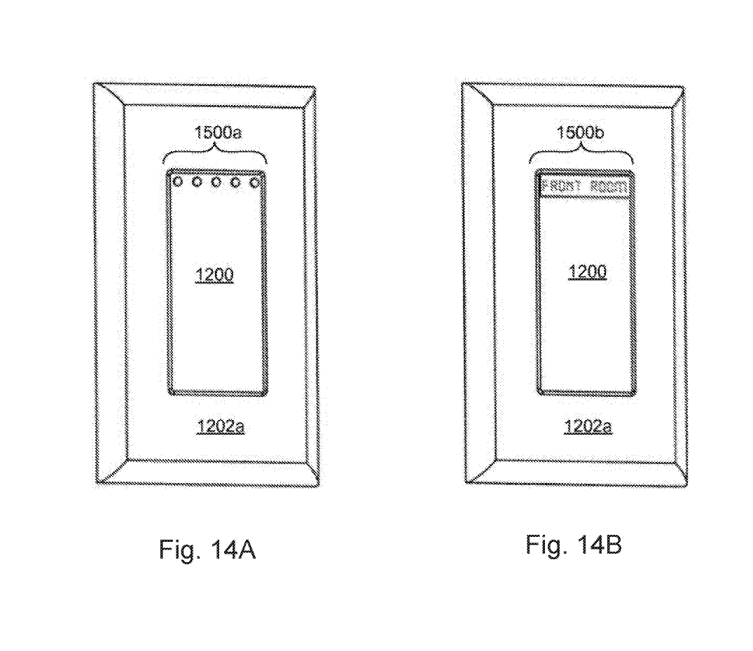

FIGS. 14A and 14B show beacons 1200 configured to provide visual feedback via an LED 1500a or set of LEDs 1500a, or a display 1500b such as a single, multi-line, or graphical LCD 1500b. The LEDs 1500a may be single or multi-color and may be used to indicate item selected, indicate a level such as temperature level for an air conditioner control, or light level for a dimmer function. This may be displayed as turning on/off discrete LEDs as the level changes or changing the color of the LEDs such as from red to blue as cooler temperature is selected through activation of the switching functions by pressing the corners or quadrants of the device. The remainder of the face of the device 1200 may be a solar cell used to charge and maintain the operating power requirements of the device. Lights 1500a or displays 1500b may be arranged as desired for functions around edges of the device to provide data/feedback on selection and status of selected functions.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A retractable privacy system comprising:
two or more drums, each of the drums containing one or more motors inside each of the respective drums;
a flexible sheet rotated around each of the respective drums by the respective motors to roll-up or roll-down the respective flexible sheets;
the respective flexible sheets each having side edges which are parallel to each other and perpendicular to a top edge and a bottom edge of the respective flexible sheets;
a flexible mating surface attached to each side edge of each of the respective flexible sheets, wherein the flexible mating surface is configured to connect with the flexible mating surface of the adjacent flexible sheet;
a battery located inside the respective drums to power the respective motors and a motor controller disposed within the respective drums;
a beacon comprising a communication tilt plate comprising a front side and a back side, the front side comprising an outer touch surface and the back side comprising electronic components mounted thereon and the back side further comprising a raised center pivot and a plurality of spring loaded switches mounted thereon disposed around the periphery of the back side of the tilt plate such that by tilting the communication tilt plate by pressing proximate the periphery of the outer touch surface one or more of the spring-loaded switches are activated to communicate commands to the respective motor controllers, wherein the respective motor controllers receive commands to roll-up or roll-down the respective adjacent flexible sheets thereby connecting and disconnecting the respective flexible mating surfaces of the respective flexible sheets.

2. The retractable privacy system of claim 1, wherein each of the respective motor controllers are networked together.

3. The retractable privacy system of claim 2, wherein rolling up and rolling down the respective flexible sheets is synchronized.

4. The retractable privacy system of claim 1, wherein each sheet material is at least partially made of at least one of a plastic, nylon, polyvinylidene fluoride, polyethylene, metal, lead, a metal alloy, polyvinylchloride, or vinyl.

5. The retractable privacy system of claim 2, wherein each of the respective motor controllers are wirelessly controlled.

6. The retractable privacy system of claim 1, wherein at least one of the respective flexible sheets is rolled up or rolled down at least partially based on at least one of: a light level, a sound level, a temperature, a detection of nuclear particles, a time-of-day setting, a user input, a security system input, an insulation value setting, a sound threshold setting, a proximity detection, a wireless control signal, a voice activation signal, a voice recognition signal, a humidity signal, a vision system signal, a detected obstruction, or a sensed load.

7. The retractable privacy system of claim 1, wherein the respective flexible sheets are used as at least one of: a wall, a window, a door, a roof or a garage door.

8. The retractable privacy system of claim 6, wherein the light level is determined based on the light level within a 24-hour period.

9. The retractable privacy system of claim 1, wherein the respective flexible sheets are used to partition an open area into smaller areas.

10. The retractable privacy system of claim 9, wherein the respective flexible sheets magnetically connect to a floor or ground plane.

11. A method comprising:
rotating two or more drums, each of the drums containing one or more motors to roll up or roll down respective flexible sheets wound about the respective drums, the one or more motors being inside of each of the respective drums and the respective flexible sheets each having side edges which are parallel to each other and perpendicular to a top and a bottom edge of the respective flexible sheets;
controlling the respective motors with a motor controller and a battery which are located in each of the respective drums;
providing a beacon comprising a communication tilt plate comprising a front side and a back side, the front side comprising an outer touch surface and the back side comprising electronic components mounted thereon and the back side further comprising a raised center pivot and a plurality of spring loaded switches mounted thereon disposed around the periphery of the back side of the tilt plate such that by tilting the communication tilt plate by pressing proximate the periphery of the outer touch surface one or more of the spring-loaded switches are activated to communicate commands to the respective motor controllers, and
mating two or more of the respective flexible sheets with a flexible mating surface attached to each side edge of each of the respective flexible sheets when the respective motor controller commands the respective motors to roll up or roll down respective flexible sheets.

12. The method of claim 11, wherein each of the respective controllers are networked together.

13. The method of claim 12, wherein rolling up or rolling down the respective flexible sheets is synchronized.

14. The method of claim 11, wherein the respective flexible sheet material is at least partially made of at least one of a plastic, nylon, polyvinylidene fluoride, polyethylene, metal, lead, a metal alloy, polyvinylchloride, or vinyl.

15. The method of claim 11, wherein the respective motor controllers are wirelessly controlled.

16. The method of claim 11, wherein at least one of the respective flexible sheets rolled up or rolled down at least partially based on at least one of: a light level, a sound level, a temperature, a detection of nuclear particles, a time-of-day setting, a user input, a security system input, an insulation value setting, a sound threshold setting, a proximity detection, a wireless control signal, a voice activation signal, a voice recognition signal, a humidity signal, a vision system signal, a detected obstruction, or a sensed load.

17. The method of claim 16, wherein the respective flexible sheets are used as at least one of: a wall, a window, a door, a roof or a garage door.

18. The method of claim 16, wherein the light level is determined based on the light level within a 24-hour period.

19. The method of claim 11, wherein the respective motor controllers are in communication with a thermostat, a security system, a network, or a personal user device.

20. The method of claim 11, wherein the respective motor controllers are in communication a battery-less transmitter.
